(19) United States
(12) Patent Application Publication
(10) Pub. No.: US 2025/0283814 A1
(43) Pub. Date: Sep. 11, 2025

(54) METHOD FOR OPTICAL EMISSION SPECTROSCOPY (OES) DETECTOR SIGNAL SENSITIVITY IMPROVEMENT

(71) Applicant: Tokyo Electron Limited, Tokyo (JP)

(72) Inventors: Blaze MESSER, Albany, NY (US); Sergey VORONIN, Albany, NY (US); Da SONG, Albany, NY (US); Yan CHEN, Fremont, CA (US); Joel NG, Fremont, CA (US)

(73) Assignee: Tokyo Electron Limited, Tokyo (JP)

(21) Appl. No.: 18/597,379

(22) Filed: Mar. 6, 2024

(51) Int. Cl. G01N 21/64

(52) U.S. Cl. CPC G01N 21/6402

(57) ABSTRACT

Aspects of the present disclosure provide a method for optical emission spectroscopy (OES) detector signal sensitivity improvement. For example, the method can include scanning OES spectra of an optical emission, and defining all wavelengths of the optical emission whose intensities do not satisfy a predetermined requirement. The method can further include adjusting the intensity of each of the defined wavelengths by a first predetermined factor, and calculating an amplification/attenuation coefficient corresponding to the intensity of the defined wavelength based on the first predetermined factor. The method can further include conducting data analysis on the optical emission by taking into account all the amplification/attenuation coefficients.

### FIELD OF THE INVENTION

The present disclosure relates to improvement to optical emission spectroscopy (OES) detector signal sensitivity.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Optical emission spectroscopy (OES) enables analysis of elemental composition of samples. The intensities of spectra lines of OES spectra across one or more wavelengths may be too large to be within a detection range or to small to be detected.

### SUMMARY

Aspects of the present disclosure provide a method for optical emission spectroscopy (OES) detector signal sensitivity improvement. For example, the method can include scanning OES spectra of an optical emission and defining all wavelengths of the optical emission whose intensities do not satisfy a predetermined requirement. The method can further include adjusting the intensity of each of the defined wavelengths by a first predetermined factor and calculating an amplification/attenuation coefficient corresponding to the intensity of the defined wavelength based on the first predetermined factor. The method can further include conducting data analysis on the optical emission by taking into account all the amplification/attenuation coefficients.

In an embodiment, the method can further include adjusting the intensity of each of the defined wavelengths, which is adjusted by the first predetermined factor, by a second predetermined factor if the intensity of the defined wavelength still does not satisfy the predetermined requirement, wherein the amplification/attenuation coefficient is calculated based on the first predetermined factor and the second predetermined factor. In some embodiments, the amplification/attenuation coefficient can be calculated by multiplying the first predetermined factor and the second predetermined factor. In an embodiment, the first predetermined factor can be equal to the second predetermined factor. In another embodiment, the first predetermined factor can be different from the second predetermined factor. For example, the first predetermined factor can be greater than the second predetermined factor.

In an embodiment, the predetermined requirement can include a maximum threshold, and adjusting the intensity of each of the defined wavelengths by the predetermined factor can include reducing the intensity of each of the defined wavelengths by the predetermined factor. For example, the maximum threshold can correspond to a greatest one of intensities within a detection range of the OES spectra. As another example, the maximum threshold can correspond to 80% of a greatest one of intensities within a detection range of the OES spectra. In another embodiment, the predetermined requirement can include a minimum threshold, and adjusting the intensity of each of the defined wavelengths by the predetermined factor can include increasing the intensity of each of the defined wavelengths by the predetermined factor.

Aspects of the present disclosure also provide an apparatus for OES detector signal sensitivity improvement. For example, the apparatus can include an OES detector configured to scan OES spectra of an optical emission and define all wavelengths of the optical emission whose intensities do not satisfy a predetermined requirement. The apparatus can further include a gain adjusting module coupled to the OES detector, the gain adjusting module configured to adjust the intensity of each of the defined wavelengths by a first predetermined factor. The apparatus can further include an analog-to-digital converter (ADC) coupled to the gain adjusting module, the ADC configured to convert the intensity of each of the defined wavelengths from an analog format to a digital format. The apparatus can further include a controller coupled to the ADC and the gain adjusting module, the controller configured to determine whether the intensity of each of the defined wavelengths in the digital format satisfies a predetermined requirement, generate the first predetermined factor if the intensity of the defined wavelength does not satisfy the predetermined requirement, calculate an amplification/attenuation coefficient corresponding to the intensity of the defined wavelength based on the first predetermined factor, and conduct data analysis on the optical emission by taking into account all the amplification/attenuation coefficients.

In an embodiment, the controller can be further configured to adjust the intensity of each of the defined wavelengths, which is adjusted by the first predetermined factor, by a second predetermined factor if the intensity of the defined wavelength still does not satisfy the predetermined requirement, and calculate the amplification/attenuation coefficient based on the first predetermined factor and the second predetermined factor. In some embodiments, the controller can be configured to calculate the amplification/attenuation coefficient by multiplying the first predetermined factor and the second predetermined factor.

In an embodiment, the predetermined requirement can include a maximum threshold, and the gain adjusting module can be configured to adjust the intensity of each of the defined wavelengths by reducing the intensity of each of the defined wavelengths by the predetermined factor. In another embodiment, the predetermined requirement can include a maximum threshold, and the gain adjusting module can be configured to adjust the intensity of each of the defined wavelengths by increasing the intensity of each of the defined wavelengths by the predetermined factor.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a schematic diagram of an optical analyzer apparatus that makes use of optical emission spectroscopy (OES) according to some embodiments of the present disclosure;

FIG. 2 is a schematic diagram illustrating an exemplary spectrometer system according to some embodiments of the present disclosure;

FIG. 3 is a spectra diagram illustrating the intensity distribution of light that is analyzed by a spectrometer system across a range of wavelengths;

FIG. 4 is a functional block diagram of an exemplary optical analyzer apparatus for OES detector signal sensitivity improvement according to some embodiments of the present disclosure;

FIG. 5 is a flow chart illustrating an exemplary method for OES detector signal sensitivity improvement according to some embodiments of the present disclosure; and

FIG. 6 is a spectra diagram illustrating the intensity distribution of light that is analyzed by the optical analyzer apparatus of FIG. 4 across a range of wavelengths according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

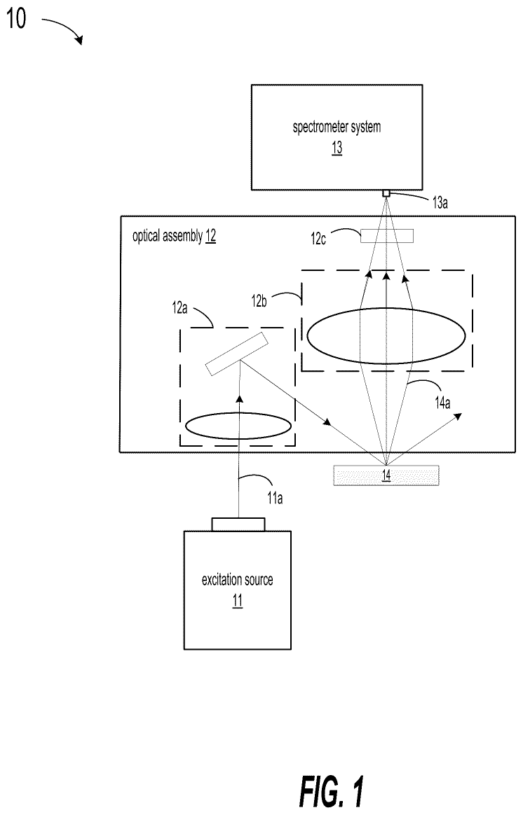

Optical emission spectroscopy (OES) is a reliable and extensively used elemental analysis technique used to analyze the elemental composition of samples, such as metals and alloys, and to detect the presence and relative concentrations of various gas species in a process chamber, in which deposition and etching, for example, are performed in a plasma environment. OES involves the collection, spectral dispersion, and detection of light. FIG. 1 is a schematic diagram of an optical analyzer apparatus 10 (or an OES system) that makes use of OES according to some embodiments of the present disclosure. The optical analyzer apparatus 10 can include an excitation source 11, an optical assembly optically coupled to the excitation source 11, a spectrometer system 13 optically coupled to the optical assembly 12, and a controller 15 electrically coupled to the excitation source 11 and the spectrometer system 13. In an embodiment, the controller 15 can be provided by a computer that includes a processor and a memory, the memory being configured to store computer instructions, programs and/or algorithms that, when executed by the processor, causes to the computer to operate as the controller 105 according to some embodiments of the present disclosure.

The excitation source 11 can be controlled by the controller 15 to generate tunable excitation 11a to invoke an optical emission 14a emitted from a sample 14. In an embodiment, the excitation source 11 can include a laser source that is configured to generate a single laser pulse of a series of laser pulses of high peak power that can be focused by the optical assembly 12 to the sample 14 to form a plasma plume on the surface of the sample 14. During the plasma formation, free electrons start to recombine with ions, which invokes from the sample 14 the optical emission at wavelength(s) that characterize the elements on the surface of the sample 14.

The optical assembly 12 can be configured to focus the excitation 11a onto the surface of the sample 14 and transferring the optical emission 14a emitted from the sample 14 into the spectrometer system 13. In an embodiment, the optical assembly 12 can include one or more collecting and focusing lens and mirrors 12a that are configured to collect and focus the excitation 11a generated by the excitation source 11, e.g., the laser pulses generated by the laser source, onto the surface of the sample 14. In another embodiment, the optical assembly 12 can further include one or more focusing lens and mirrors 12b that are configured to focus the optical emission 14a into the spectrometer system 13, e.g., via an input fiber cable (not shown) and a connector 13a to which the fiber cable is secured. In some embodiments, the optical assembly 12 can further include a filter 13c, e.g., a notch filter that is configured to attenuate frequencies within a specific range while passing all other frequencies unaltered.

The spectrometer system 13 can be configured to determine the elemental composition of the sample 14 according to the optical emission 14a transferred thereinto, for example, by analyzing the intensity distribution of the dispersed optical emission 14a across a range of wavelengths.

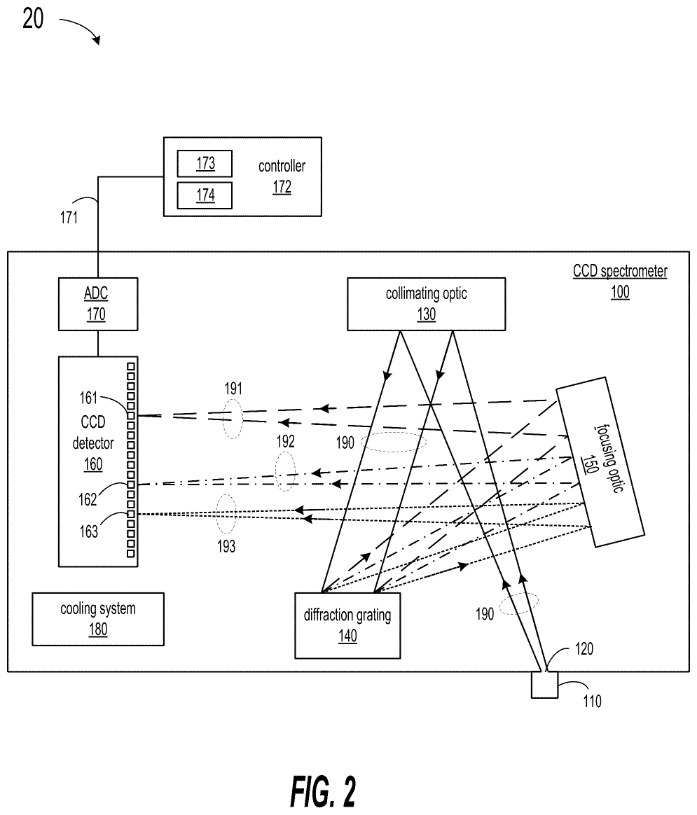

FIG. 2 is a schematic diagram illustrating an exemplary spectrometer system 20, e.g., the spectrometer system 13, according to some embodiments of the present disclosure. A connector 110 can secure an input fiber cable (not shown) to a spectrometer 100. For example, the connector 110 can be a subminiature version A (SMA) connector. As another example, the input fiber can be an UV/DUV single core fiber cable. The input fiber can couple the light 190 generated from a light source, e.g., the optical emission 14a emitted from the sample 14 shown in FIG. 1, to the spectrometer 100.

The spectrometer 100 can be used to determine spectral characteristics about an object and/or element through analysis of its interactions with light or of the spectral components (or spectral lines) of the light itself. The spectrometer can be configured to separate and measure the distinct spectral components of light. There are two kinds of spectrometers according to different light-collecting techniques. One is a scanning spectrometer, which can collect light exiting from an exit slit by using a single-channel detector, such as photomultiplier tube (PMT) detector and silicon detector, that is positioned behind the exit slit. The scanning spectrometer may include a diffraction grating, which is driven by a stepper motor to rotate in steps of predetermined degrees (scanning step number) such that light of a specific wavelength can reach the exit slit and be detected by the PMT detector. In another embodiment, a scanning spectrometer can include a hyperspectral imaging system, where wavelength scanning is accomplished by scanning the passband of an optical filter placed in front on an imaging device. For example, the hyperspectral imaging system can include collecting optics, a wavelength tunable filter (i.e., the optical filter), and an array detector (i.e., the imaging system). The collecting optics can collect an optical signal, the wavelength tunable filter can tune the wavelengths of the collected optical signal such that the tuned optical signal can have certain scanning step passband wavelength numbers, and the tuned optical signal can be projected onto the array detector. An exemplary hyperspectral imaging system is described in US 2020/0372629 A1 and US 2020/0373210 A1, which are incorporated therein for reference in their entirety. The other kind of spectrometers is a charge coupled device (CCD) spectrometer, which can collect light from a fixed diffraction grating by using a multi-channel CCD, or other type of detector, e.g. a CMOS detector, photodiode array, etc. Accordingly, the CCD spectrometer can collect the whole spectrum of the light simultaneously.

A slit 120 can be mounted behind the connector 110. The slit 120 can control the amount of the light 190 (i.e., photon flux) that enters the spectrometer 100 and limit the spatial distribution of the light 190. The slit 120 typically is rectangular and on the order of the wavelength of the light to be measured, e.g., the light 190. For example, the slit 120 can be sized from 5 μm to 800 μm in width and 1 mm to 2 mm in height. After passing through the slit 120, the light 190 will be redefined with a Voigt function that is the convolution of the Lorentzian function and an instrumental broadening function, which is attributable to the non-negligible width of the slit 120 and is typically a Gaussian function. The width of the slit 120 can thus affect the spectral resolution (or the spectral bandpass (BP)) of the spectrometer 100; the narrower the slit 120, the higher the spectral resolution. However, the slit 120 that is narrow can decrease the strength and signal-to-noise ratio (SNR) of the light 190 that enters the spectrometer 100. In an embodiment, the SNR of the light 190 can be increased by averaging multiple measurements or by a moving average method.

A collimating optic 130 can ensure that the light 190 from the slit 120 travels toward a diffraction grating 140 in a parallel, collimated fashion because the diffraction grating 140 can only work correctly if it is illuminated with collimated light. For example, the collimating optic 130 can be a lens, which can be disposed along an optical path from the slit 120 to the diffraction grating 140. As another example, the collimating optic 130 can be a mirror (e.g., an off-line spherical mirror), which can be disposed beside the slit 120 and the diffraction grating 140, and be disposed such that the slit 120 is located at its focal point.

The diffraction grating 140 can diffract (or separate) the collimated light 190 from the collimating optic 130 into a plurality of spectral components, e.g., the first to third spectral components 191 to 193, and direct the separated first to third spectral components 191 to 193 onto a focusing optic 150 at different positions. The first to third spectral components 191 to 193, which have different wavelengths, can leave the diffraction grating 140 at different angles, but a bundle of light of each of the first to third spectral components 191 to 193 can leave the diffraction grating 140 at the same angle. The groove density (or groove frequency) of the diffraction grating 140, i.e., the amount of grooves per mm, can determine the ability (i.e., the spectral BP and spectral resolution) of the spectrometer 100 to discriminate between adjacent spectral components, e.g., the first to third spectral components 191 to 193. The groove facet angle (or blaze angle) of the diffraction grating 140 can determine the overall shapes of the first to third spectral components 191 to 193. In an embodiment, the diffraction grating 140 can be blazed to provide high diffraction efficiency at a specific wavelength, i.e., a blaze wavelength (λ_{B}). The diffraction efficiency will decrease by 50% at 0.6×λ_{B} and 1.8×λ_{B}. The SNR of the spectrometer 100 can be improved by biasing the blaze wavelength of the diffraction grating 140 toward the weak side of the spectral range.

In an embodiment, the diffraction grating 140 can be transmissive, like a multi-slit aperture, and be disposed along an optical path from the collimating optic 130 to the focusing optic 150. In another embodiment, the diffraction grating 140 can be reflective, with its grooved surface (representing the multi-slit aperture) coated with a highly reflective material, such as aluminum, and be disposed beside the collimating optic 130 and the focusing optic 150.

In an embodiment, the diffraction grating 140 can be a ruled grating, which is formed by etching a plurality of parallel, angled grooves onto the surface of a substrate and coating the grooves with a highly reflective material. In another embodiment, the diffraction grating 140 can be a holographic grating, which is formed by interfering two UV beams in a fringe field having a standing-wave pattern exposed to a polished substrate coated with photoresist, and thus has sinusoidal cross-sectional grooves. As compared with the ruled grating, the holographic grating can exhibit much less stray light, but is more difficult to be blazed due to its sinusoidal groove profile.

The focusing optic 150 can focus the separated first to third spectral components 191 to 193 onto a detector 160 at different positions based on their different wavelengths. For example, the focusing optic 150 can focus the first to third spectral components 191 to 193 onto first to third pixels 161 to 163 of the detector 160, respectively, and the pixel numbers (or pixel positions in nm) of the first to third pixels 161 to 163 can be associated with the wavelengths of the first to third spectral components 191 to 193. In an embodiment, the focusing optic 150 can be a lens, which can be disposed along an optical path from the diffraction grating 140 to the detector 160. In another embodiment, the focusing optic 150 can be a mirror, which can be disposed beside the diffraction grating 140 and the detector 160.

The detector 160 can be, for example, a CCD, a CMOS sensor, a photodiode array detector, or any other type of array detector. The detector 160 can be arranged on a focal plane of the focusing optic 150, and collect the first to third spectral components 191 to 193 from the focusing optic 150. For example, the detector 160 can include a plurality of array-based or linearly arranged pixels, e.g., the first to third pixels 161 to 163, which can respond to and interact with the first to third spectral components 191 to 193 that strike them, respectively, and build up their respective charges; the brighter the spectral component (or the higher the intensity of the spectral component) and/or the longer the interaction, the more charge is built. In an embodiment, the detector 160 can include 1,024 linearly arranged pixels. In another embodiment, the detector 160 can include 2,048 linearly arranged pixels. The detector 160 can then output analog signals according to the built charges of the pixels. The analog signals output by the detector 160 may be too high to be directly coupled to an analog-to-digital converter (ADC) 170. In such a scenario, the analog signals have to be linearly inverted, amplified and shifted before passing to the ADC 170. The ADC 170 can convert the processed analog signals into digital signals and transmit the digital signals to a controller 172 for further processing. In an embodiment, the controller 172 can include a processor 173 and a memory 174 coupled to the processor 173. For example, the memory 174, e.g., a non-transitory computer-readable storage medium, can have stored therein a variety of instructions, programs and algorithms that, when executed by the processor 173, can cause the controller 172 to perform some associated operations. In an embodiment, the processor 173 and the non-transitory computer-readable storage medium 174 can be installed in an external computer, and the computer can be coupled to the spectrometer 100 via an interface 171. For example, the interface 171 can be a universal serial bus (USB).

Optionally, the spectrometer 100 can be equipped with a cooling system 180 if it is to be in measurement of the light 190 with long integration time. For example, the cooling system 180 can be a thermoelectric cooler (TEC). Even when no protons are impinging on the detector 160 and thus no electrons will be excited and no current will be generated accordingly, there are still some electrons that will be excited spontaneously due to their thermal energy, thus generating a dark current. The dark current can accumulate over the integration time, and can affect the measurement of the detector 160 significantly if the integration time is over, for example, 100 ms. Because the dark current comes from thermal fluctuations, lowering the operating temperature of the detector 160 can be a way to decrease the dark current. In an embodiment, the cooling system 180 can be arranged close to the detector 160 to reduce the dark current, thereby reducing the corresponding dark noises and enhancing the dynamic range of the spectrometer 100.

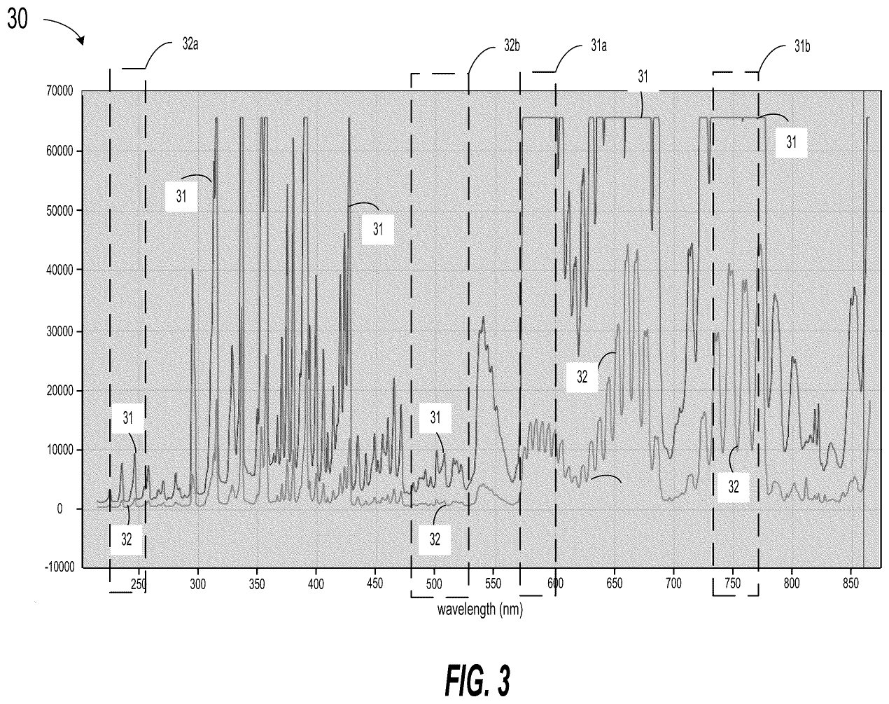

The optical analyzer apparatus 10 can scan a broad wavelength spectra, some of spectra lines of which may have low intensities, while the other spectra lines of which may be out of the detection range. FIG. 3 is a spectra diagram 30 illustrating the intensity distribution of light, e.g., the dispersed optical emission 14a, that is analyzed by a spectrometer system, e.g., the spectrometer system 20, across a range of wavelengths. As shown, spectra lines of an original wavelength spectra 31 of the optical emission 14a across first and second wavelength ranges 31a and 31b are out of the detection range and their intensities are thus truncated. In order to determine the correct intensities of the spectra lines across the first and second wavelength ranges 31a and 31b, the power of laser pulses, e.g., the excitation 11a, generated by an excitation source, e.g., the excitation source 11, to invoke the optical emission 14a to be emitted from the sample 14, has to be reduced (e.g., becoming 20% of the original intensity), or alternatively or simultaneously the analog signals of the pixels of the detector 160 of the CCD spectrometer 100 have to be attenuated, and the original wavelength spectra 31 can thus be modified to become a modified wavelength spectra 32, in which the intensities of the spectra lines across the first and second wavelength ranges 31a and 31b are within the detection range shown in the spectra diagram 30.

As the OES system 10 treats the optical emission 14a across all the wavelengths equally at hardware (HW) level and the gain/attenuation for all wavelengths is the same, in the modified wavelength spectra 32, not only the intensities of the spectra lines across the first and second wavelength ranges 31a and 31b are reduced, the intensities of the other spectra lines are also reduced, some of which may thus have too small the intensities to be detected. For example, the intensities of the spectra lines of the modified wavelength spectra 32 across third and fourth wavelength ranges 32a and 32b, which are reduced to become 20% of the intensities of the spectra lines of the original wavelength spectra 31, may be too small to be detected.

In order to maintain the best signal-to-noise ratio (SNR) and keep the maximum level of sensitivity to wave numbers of interest, aspects of the present disclosure provide mechanisms that selectively amplify (e.g., gain adjustment) or suppress (e.g., attenuation adjustment) of individual spectra lines at hardware (HW) or software (SF) level.

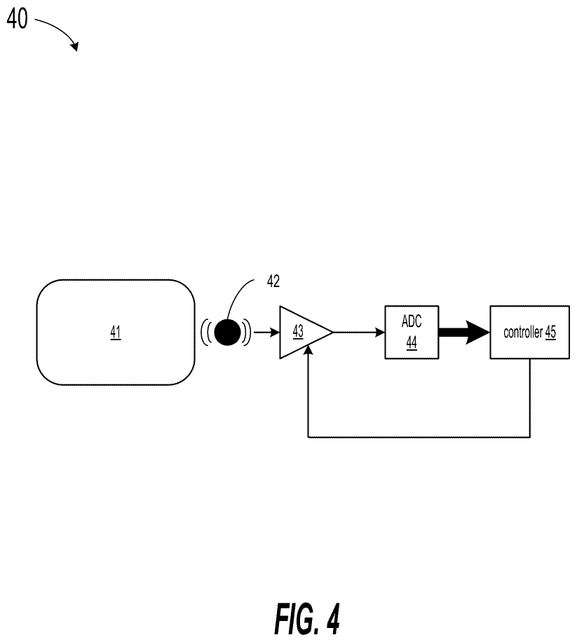

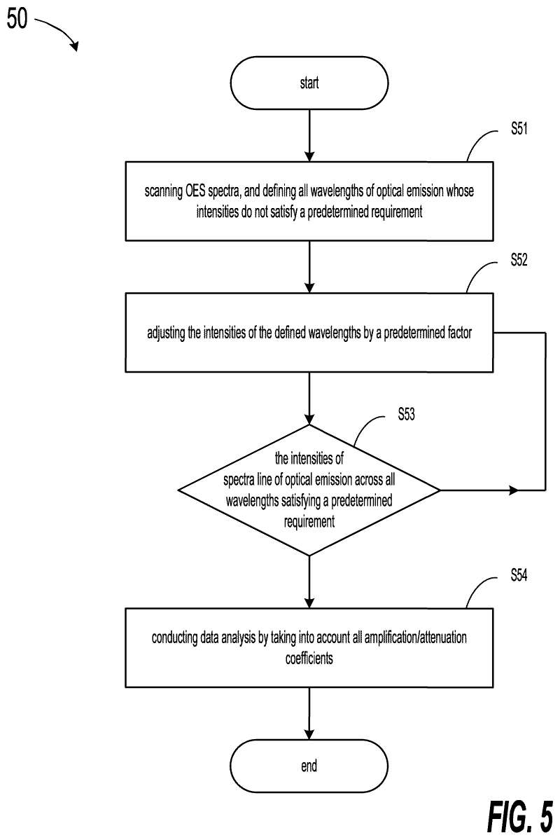

FIG. 4 is a functional block diagram of an exemplary optical analyzer apparatus 40 (or an OES system) for OES detector signal sensitivity improvement according to some embodiments of the present disclosure. FIG. 5 is a flow chart illustrating an exemplary method 50 for OES detector signal sensitivity improvement according to some embodiments of the present disclosure. In various embodiments, some of the steps of the method 50 shown can be performed concurrently or in a different order than shown, can be substituted by other method steps, or can be omitted. Additional method steps can also be performed as desired. Aspects of the method 50 can be implemented by an optical analyzer apparatus, such as the optical analyzer apparatus 40.

The optical analyzer apparatus 40 can be configured to generate an excitation whose power is tunable and/or adjust the gain of analog signals of pixels of a detector of a spectrometer, e.g., the pixels of the detector 160 of the spectrometer 100, according to whether the intensities of spectra lines emitted from a sample (e.g., various gas species in a process chamber 41) satisfy a predetermined requirement, such as whether the intensities of the spectra lines exceed an upper threshold or are smaller than a minimum threshold. In an embodiment, various processes, such as deposition and etching, can be performed in the process chamber 41.

In an embodiment, the system 400 can include an OES detector 42, a gain adjusting module 43, an ADC 44 and a controller 45. The method 50 can start at step S51, at which the OES spectra (including all the spectra lines of the optical emission 14a) can be scanned, and all wavelengths whose intensities do not satisfy the predetermined requirement can be defined. For example, the spectra lines of the optical emission 14a whose intensities exceed a maximum threshold, e.g., a greatest one or 80% of the greatest one of intensities within the detection range, can be defined. As another example, the spectra lines of the optical emission 14a whose intensities are less than a minimum threshold, e.g., 5% of the detection range, can be defined.

In an embodiment, the OES detector 42 can be configured to scan OES spectra of an optical emission and define all wavelengths of the optical emission whose intensities do not satisfy a predetermined requirement. In an embodiment, the OES detector 42 can include the OES system 10, and the controller 45 can control the gain adjusting module 43 to adjust the power of the excitation 11a generated by the excitation source 11 according to the intensities of the spectra lines of the optical emission 14a across a range of wavelengths. The method 50 can proceed to step S52, at which the intensities of the defined wavelengths, which do not satisfy the predetermined requirement, can be adjusted by a predetermined factor, and amplification/attenuation coefficients corresponding to the intensities of the defined wavelengths can be calculated. For example, when the intensity of a first spectra line of the optical emission 14a across a first wavelength exceeds the maximum threshold, the controller 45 can control the gain adjusting module 43 to reduce the power of the excitation 11a by a first predetermined factor, e.g., 2. As another example, when the intensity of a second spectra line of the optical emission 14a across a second wavelength is less than the minimum threshold, the controller 45 can control the gain adjusting module 43 to increase the power of the excitation 11a by a second predetermined factor, e.g., 2. In another embodiment, the OES detector 42 can include the CCD spectrometer 100, and the controller 45 can control the gain adjusting module 43 to adjust the gain of the analog signals of the pixels of the detector 160 of the CCD spectrometer 100. For example, when the intensity of a third spectra line of the optical emission 14a across a third wavelength exceeds the maximum threshold, the controller 45 can control the gain adjusting module 43 to reduce the gain of (i.e., to attenuate) the analog signals of the pixel by a third predetermined factor, e.g., 2. As another example, when the intensity of a fourth spectra line of the optical emission 14a across a fourth wavelength is less than the minimum threshold, the controller 45 can control the gain adjusting module 43 to increase the gain of (i.e., to amplify) the analog signals of the pixels by a fourth predetermined factor, e.g., 2. In various embodiment, the predetermined factor can be included in a pixel-dependent vector such that each wavelength (or pixel) can have its own predetermined factor. The method 50 can proceed to step S53.

At step S53, it is determined whether the adjusted intensities of the spectra lines, e.g., the first to fourth spectra lines, of the optical emission 14a across the defined wavelengths, e.g., the first to fourth wavelengths, satisfy the predetermined requirement. The method 50 can proceed to step S52 if the adjusted intensities of the spectra lines of the optical emission 14a across the defined wavelengths still do not satisfy the predetermined requirement, the amplification/attenuation coefficients being calculated by multiplying the multiple predetermined factors; otherwise, the method 50 can proceed to step S54, at which the intensities of all the spectra lines of the optical emission 14a satisfy the predetermined requirement and data analysis can be conducted by taking into account all amplification/attenuation coefficients. In an embodiment, the predetermined factor used for adjusting the intensities of the spectra lines of the optical emission 14a across the defined wavelengths at step S52 that is proceeded by the method 50 from step S51 can be different from or equal to the predetermined factor used for adjusting the intensities of the spectra lines at step S52 that is proceeded from step S53. That is to say, the predetermined factors used for adjusting the intensities of the spectra lines at every iteration of steps S52 and S53 can be different from or equal to each other. In an embodiment, the predetermined factor used for adjusting the intensities of the spectra lines at step S52 executed previously can be greater than the predetermined factor used for adjusting the intensities of the spectra lines at step S52 executed subsequently.

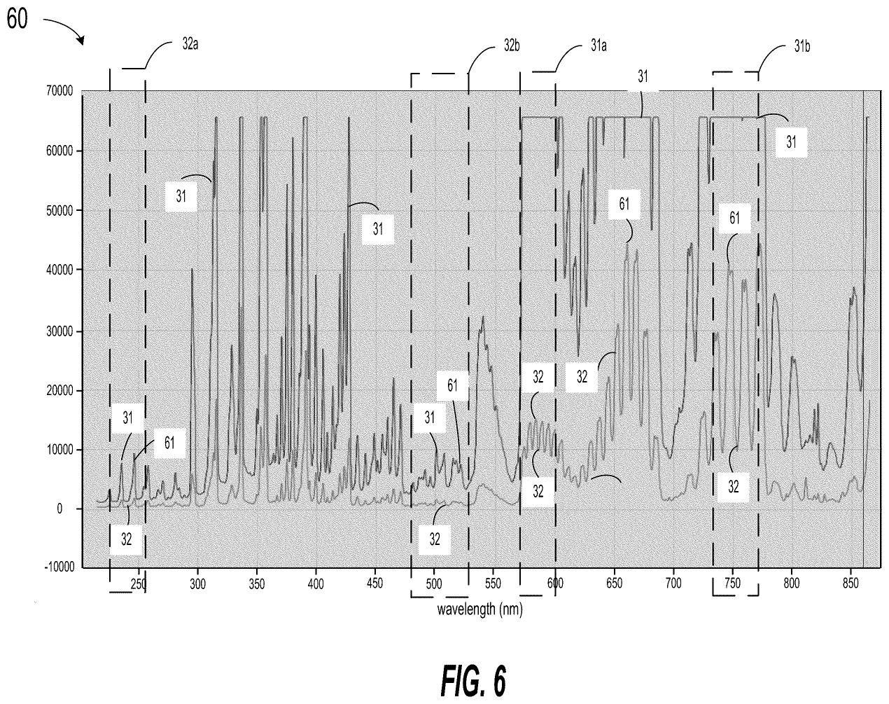

FIG. 6 is a spectra diagram 60 illustrating the intensity distribution of light, e.g., the dispersed optical emission 14a, that is analyzed by a spectrometer system, e.g., the OES system 40, across a range of wavelengths that includes the first to fourth wavelength ranges 31a, 31b, 32a and 32b according to some embodiments of the present disclosure. Different from the spectra diagram 30, which illustrates the original wavelength spectra 31, the spectra lines of which within the first and second wavelengths 31a and 31b have intensities out of the detection range, and the modified wavelength spectra 32, the spectra lines of which within the third and fourth wavelengths 32a and 32b have intensities that are too small to be detected, the spectra diagram 60 illustrates a selectively modified wavelength spectra 61 that includes the spectra lines of the modified wavelength spectra 32 within the first and second wavelength ranges 31a and 31b, the intensities of which are out of the detection range initially and are modified to satisfy the predetermined requirement, i.e., less than the maximum threshold, and the spectra lines of the original wavelength spectra 31 within the third and fourth wavelength ranges 32a and 32b, the intensities of which are within the detection range and no modification is required to be conducted thereon.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “target substrate” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a dielectric layer on or overlying a base substrate structure such as a thin film. Thus, substrate is not limited to any particular base structure, underlying dielectric layer or overlying dielectric layer, patterned or un-patterned, but rather, is contemplated to include any such dielectric layer or base structure, and any combination of dielectric layers and/or base structures. The description may reference particular types of substrates, but this is for illustrative purposes only.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A method, comprising:
scanning optical emission spectroscopy (OES) spectra of an optical emission, and defining all wavelengths of the optical emission whose intensities do not satisfy a predetermined requirement;
adjusting the intensity of each of the defined wavelengths by a first predetermined factor, and calculating an amplification/attenuation coefficient corresponding to the intensity of the defined wavelength based on the first predetermined factor; and
conducting data analysis on the optical emission by taking into account all the amplification/attenuation coefficients.

2. The method of claim 1, further comprising:
adjusting the intensity of each of the defined wavelengths, which is adjusted by the first predetermined factor, by a second predetermined factor if the intensity of the defined wavelength still does not satisfy the predetermined requirement,
wherein the amplification/attenuation coefficient is calculated based on the first predetermined factor and the second predetermined factor.

3. The method of claim 2, wherein the amplification/attenuation coefficient is calculated by multiplying the first predetermined factor and the second predetermined factor.

4. The method of claim 2, wherein the first predetermined factor is equal to the second predetermined factor.

5. The method of claim 2, wherein the first predetermined factor is different from the second predetermined factor.

6. The method of claim 5, wherein the first predetermined factor is greater than the second predetermined factor.

7. The method of claim 1, wherein the predetermined requirement includes a maximum threshold, and adjusting the intensity of each of the defined wavelengths by the predetermined factor includes reducing the intensity of each of the defined wavelengths by the predetermined factor.

8. The method of claim 7, wherein the maximum threshold corresponds to a greatest one of intensities within a detection range of the OES spectra.

9. The method of claim 7, wherein the maximum threshold corresponds to 80% of a greatest one of intensities within a detection range of the OES spectra.

10. The method of claim 1, wherein the predetermined requirement includes a minimum threshold, and adjusting the intensity of each of the defined wavelengths by the predetermined factor includes increasing the intensity of each of the defined wavelengths by the predetermined factor.

11. An apparatus, comprising:
an optical emission spectroscopy (OES) detector configured to scan OES spectra of an optical emission and define all wavelengths of the optical emission whose intensities do not satisfy a predetermined requirement;
a gain adjusting module coupled to the OES detector, the gain adjusting module configured to adjust the intensity of each of the defined wavelengths by a first predetermined factor;
an analog-to-digital converter (ADC) coupled to the gain adjusting module, the ADC configured to convert the intensity of each of the defined wavelengths from an analog format to a digital format; and
a controller coupled to the ADC and the gain adjusting module, the controller configured to determine whether the intensity of each of the defined wavelengths in the digital format satisfies a predetermined requirement, generate the first predetermined factor if the intensity of the defined wavelength does not satisfy the predetermined requirement, calculate an amplification/attenuation coefficient corresponding to the intensity of the defined wavelength based on the first predetermined factor, and conduct data analysis on the optical emission by taking into account all the amplification/attenuation coefficients.

12. The apparatus of claim 11, wherein
the controller is further configured to adjust the intensity of each of the defined wavelengths, which is adjusted by the first predetermined factor, by a second predetermined factor if the intensity of the defined wavelength still does not satisfy the predetermined requirement, and calculate the amplification/attenuation coefficient based on the first predetermined factor and the second predetermined factor.

13. The apparatus of claim 12, wherein the controller is configured to calculate the amplification/attenuation coefficient by multiplying the first predetermined factor and the second predetermined factor.

14. The apparatus of claim 12, wherein the first predetermined factor is equal to the second predetermined factor.

15. The apparatus of claim 12, wherein the first predetermined factor is different from the second predetermined factor.

16. The apparatus of claim 15, wherein the first predetermined factor is greater than the second predetermined factor.

17. The apparatus of claim 11, wherein the predetermined requirement includes a maximum threshold, and the gain adjusting module is configured to adjust the intensity of each of the defined wavelengths by reducing the intensity of each of the defined wavelengths by the predetermined factor.

18. The apparatus of claim 17, wherein the maximum threshold corresponds to a greatest one of intensities within a detection range of the OES spectra.

19. The apparatus of claim 17, wherein the maximum threshold corresponds to 80% of a greatest one of intensities within a detection range of the OES spectra.

20. The apparatus of claim 11, wherein the predetermined requirement includes a minimum threshold, and the gain adjusting module is configured to adjust the intensity of each of the defined wavelengths by increasing the intensity of each of the defined wavelengths by the predetermined factor.
